(19) United States
(12) Patent Application Publication
(10) Pub. No.: US 2026/0220725 A1
(43) Pub. Date: Jul. 30, 2026

(54) PROGRESSIVE AGENCY

(71) Applicant: Paul Atkinson, Poway, CA (US)

(72) Inventor: Paul Atkinson, Poway, CA (US)

(21) Appl. No.: 19/459,974

(22) Filed: Jan. 26, 2026

Related U.S. Application Data
(60) Provisional application No. 63/749,060, filed on Jan. 24, 2025.

(51) Int. Cl. G06Q 50/18

(52) U.S. Cl. CPC G06Q 50/18

(57) ABSTRACT

A progressive agency system is provided that enables a progression of custodial and noncustodial stakeholders in individual items to achieve their respective purposes by way of progressive smart contracts and hardware agents that operate autonomously or independently according to electronic progressive smart contracts. It also includes novel distributed, multi-dimensional, multi-stakeholder, multi-purpose and multi-agency AI architectures, computing platforms, systems and methods.

### RELATED APPLICATIONS

This patent application claims priority to U.S. provisional patent application 63/749,060 filed Jan. 24, 2025 and entitled “Progressive Agency”, which is incorporated herein by reference in its entirety.

This application also relates to the following, all of which are incorporated herein by reference as if set forth in their entirety:
U.S. Pat. No. 11,394,547 issued Jul. 19, 2022 and U.S. patent application Ser. No. 17/734,364 filed May 2, 2022, both entitled “Transaction Agents and Systems”;
U.S. provisional patent applications 62/358,685 filed Jul. 6, 2016 and 62/354,491 filed Jun. 24, 2016, both entitled “Transaction Agents and Systems”;
U.S. Pat. No. 12,026,265 issued Jul. 2, 2024 and U.S. Pat. No. 10,853,902 issued Dec. 1, 2020, both entitled “Agents and Systems for Rights Management”;
U.S. patent application Ser. No. 18/760,796 filed Jul. 1, 2024 entitled “Agents and Systems for Right's Management”; U.S. patent application Ser. No. 18/199,178 filed Mar. 8, 2023 entitled “Autonomous Agents Using Smart Contracts To Enable Pay-For-Performance Transactions”; U.S. provisional patent application 63/439,312 filed Jan. 27, 2023 entitled “Autonomous Agents Using Smart Contracts To Enable Pay-For-Performance Transactions”; U.S. provisional patent applications 63/436,227 filed Dec. 30, 2022 and 63/338,962 filed May 6, 2022 both entitled “Agents and Systems or Rights Management”, and U.S. provisional patent application 63/317,639 and entitled “CHR-048-CXP” filed Mar. 8, 2022;
U.S. provisional patent applications 63/872,598 filed Aug. 25, 2025 and 63/764,756 filed Feb. 28, 2025, both entitled “Progressive Agency”;
U.S. patent application Ser. No. 19/060,469, filed Feb. 21, 2025 and entitled “Intelligent Agents And Systems For Condition Sensitive Items, and U.S. provisional patent application 63/556,465 filed Feb. 22, 2024 and entitled “Intelligent Agents and Systems for Temperature Sensitive Items”.

### FIELD OF INVENTION

The field of invention includes electronic computing devices-hardware agents operating autonomously or independently according to electronic progressive smart contracts. The field of invention also includes novel distributed, multi-dimensional, multi-party (multi-stakeholder), multi-purpose and multi-agency AI architectures, computing platforms, systems and methods, that are collectively referred to herein as progressive agency.

### BACKGROUND OF THE INVENTION

The healthcare of hundreds of millions of people depends on the efficacy of temperature sensitive medications. Yet today, there is no way of knowing if the individual doses of the medications they take are fit-for-use when they take them: that their efficacy hadn't been substantively degraded because of their lifetime exposure to temperature. The negative consequences (which are largely unattributed to loss of efficacy due to the cumulative exposure to temperature) ripple across the stakeholders in medications and their outcomes: patients, families, caregivers, healthcare providers, pharmaceutical companies, distributors, pharmacies, payers, employers etc.

Solutions to problems like medication fitness-for-use, of which there are many, depend on millions of different item-level combinations of parties, each having a stake in individual items, their use and outcomes, being empowered and motivated to achieve their own purpose as they relate to their stakes. And in so doing, empower and motivate, the other parties to achieve their own purposes. What's needed is a new technology and business paradigm that goes beyond the ‘edge’ and IoT, and progressively enables each party with its own agency, according to its rights, permissions, privileges and authorizations, and predetermined conditions.

Although healthcare and medication fitness-for-use is used as an example industry, it will be understood that many other industries and services could benefit from empowering multiple parties with their own agency.

### SUMMARY OF THE INVENTION

Progressive Agency is a novel paradigm for enabling a progression of custodial and noncustodial stakeholders in individual items to achieve their respective purposes by way of progressive smart contracts and hardware agents affixed to those items. Progressive smart contracts are multi-tiered—multi-dimensional. They comprise (1) a master smart contract and (2) co-resident smart subcontracts on a progressive agency computer system/platform, and (3) item-level smart subcontracts that determine the autonomous or independent operation of hardware agents, e.g., perceiving, processing and evaluating inputs, reasoning, making decisions, taking actions etc.

A progression of stakeholders can ‘join’, add to, subtract from, or otherwise modify a master smart contract, co-resident smart subcontract or item-level smart subcontracts-but only as allowed by the then current instance of the smart subcontract to be modified. In this way, the terms and conditions of each smart contract are set, or agreed to, by the stakeholders themselves (according to their rights, permissions and privileges etc.) and the rights of all the stakeholders are preserved without them having to agree to and authorize every change.

### TERMINOLOGY

The following terms are variously used in some or all of the provisional, pending and issued patents listed in the Related Application section above. Over time their commonly understood meanings may have evolved, so for the purpose of clarity, their meanings are stated below, which are to be used for describing and understanding the inventions of the present application.

### Agency

Agency is the capacity, ability or power of a party-a stakeholder-to achieve a goal or fulfill a purpose. Stakeholders obtain agency by way of their participation, or those of other stakeholders, in a progressive smart contract.

### Autonomous—Independent

Autonomous refers to the ability of a computing system or device to perceive and process sensed conditions, evaluate and reason, make decisions, take actions etc. with or without relying on external systems. From the perspective of progressive agency, control systems/platforms, hardware agents and hosts that operate according to a smart contract of a progressive smart contract, operate autonomously. They further operate independently, except when according to the current instance of the smart contract a party is allowed to register, add to, subtract from or otherwise modify the registry or the electronic contract of the smart contract. ccontract. Note that as the term independent as it is used herein, does not reflect any reliance on external inputs such as energy or connectivity.

### Electronic Contract

Master smart contracts, co-resident smart contracts and item-level smart contracts comprise electronic contracts (and registries) that in turn comprise predetermined terms, conditions and ‘rules’ (algorithms, processes, logic etc.) that can be set, added to, subtracted from, or otherwise modified by stakeholders according to each of those stakeholder's respective rights, permissions, privileges, authorizations etc.

### Hardware Agent & Hosts

Hardware agent is the general term for an ‘item-level’ computing device that operates autonomously or independently according to an item-level smart subcontract descended from a co-resident smart subcontract. Exemplary hardware agents are, but not limited to being:
single use, multi-use, reusable
flexible, semi-rigid or rigid
affixed to, or otherwise bound to, embedded in, integrated into, an item (product, good or more generally a physical ‘thing’) or it's primary or secondary packaging
standalone, portable, transportable, mobile, stationary
self-contained, e.g., as a ‘credit card’ or ‘gift card’ format or package insert (where the hardware agent is an ‘item’ unto itself)

To varying degrees hardware agents are intelligent and accordingly also referred to in the provisional and pending applications, and issued patents, listed in the Related Applications section as intelligent agents (“IAs”) and artificial intelligent agents (“AI agents”). To underscore the versatility of hardware agents, the term conditional access (“CA”) is used to describe a distinct class hardware agent that doesn't have the level of intelligence generally associated with IAs or AI agents.

The term “host” refers to a computing device (including a mobile phone, or other mobile device) or system that “hosts”; that operates according to, a smart contract of a progressive smart contract. As the term is used herein, a host is generally distinct from a successor computing device or system, although each is enabled with agency by way of data, information or digital assets conveyed from a hardware agent. Unlike hosts, successor computing devices or systems do not operate according to a smart contract of the same progressive smart contract.

### Packaging

A primary package is the first layer of protection that directly contains and is in contact with the item. By way of example, common types of primary packaging for medications include, but are not limited to, bottles, blister packs, vials, syringes, ampoules, injectors, pods and inhalers. Common types of secondary packaging include boxes and cartons, bags, shrink wrap and other outer wrapping, multipacks etc., and may include labels and inserts.

### Registry

Stakeholders ‘join’—they ‘register’ (or are preregistered) in progressive smart contracts by way of structured or de facto registries in master smart contracts or smart subcontracts.

Registries comprise explicit or implicit rights, permissions, privileges, etc., of each stakeholder in a progressive smart contract including those that determine their respective ability to add to, subtract from, or otherwise modify the current instance of a companion electronic contract. A registry and its contents may further serve a multitude of purposes as variously described in the applications and patents in the Related Application section.

### Smart Contract

A smart contract is a computer program or a transaction protocol that is intended to automatically execute, control or document events and actions according to predetermined terms and conditions. The smart contracts disclosed herein comprise an electronic contract and a registry that together, determine the autonomous or independent operation of a progressive agency computing system/platform (as it pertains to a master smart contract or smart subcontracts), and hardware agents or hosts (as they pertain to item-level smart subcontracts).

### Stakeholders

Stakeholders are parties (including individuals) that have a direct or indirect stake in (1) an item, its use or outcome, or (2) the agency, utility or performance enabled by way of a progressive smart contract. Stakeholders may be custodial, they have possession, control or care for an item. Or, they maybe noncustodial, remote from, and without possession of, an item.

### Utility

The utility of a progressive agency computing system/platform or hardware agent is its capability, capacity or power to act on behalf of each of the current and successive stakeholders to achieve their respective purposes; it is the cumulative agency of all the stakeholders. The term ‘power’ in this context includes without limitation functions and features, rights, permissions, authorizations, data, information, “proofs” (e.g., of states or conditions, events, actions, performances etc.), tokens, stored value, content, media and other ‘digital assets’, as well as the transfer of energy.

### BRIEF DESCRIPTION OF THE FIGURES

Individually and in combination the Figures illustrate novel progressive agency computing systems/platforms and services, subsystems, devices, methods and processes with hardware agents (and by extension, progressive smart contracts). The emphasis is on the progression of relationships by and between stakeholders, the distribution of autonomous-independent intelligence, the progressive instantiation of trust and the enablement of agency, that progressive agency makes possible.

Each of the figures illustrate greatly simplified, two dimensional models of systems and methods underlying a progressive smart contract. Each comprises (1) a master smart contract and one or more co-resident smart subcontracts and (2) item-level smart subcontracts for one or more hardware agents or hosts, and depending on the figure, (3) successor devices, systems or parties. It's a flexible, highly scalable, distributed intelligence paradigm that isn't limited to two dimensions; real-world implementations can have many dimensions that span millions of stakeholders and items.

In FIGS. 1-19 the registration of a new stakeholder to a then current instance of a smart contract (of any type) is indicated by a number or capital letter preceded by a “+” sign (e.g. +1 or +A), and creates a new current instance of the smart contract as indicated by the outline of an arrow. The sequence in which stakeholders first register in a smart contract is indicated by the number or letter. The numbers do not represent the cumulative number of stakeholders in a current instance of a smart contract. Note that although not shown in the figures, according to a smart contract's electronic contract and registry, a new current instance of a smart contract may be generated without a new stakeholder being registered.

In FIGS. 15-19 numbers or letters without a “+” sign (e.g., 1, 2 or A, B) indicate stakeholders registered in a master smart contract prior to the current instance illustrated. To avoid undue complexity FIGS. 1-20 do not show communications/interactions with users, devices or systems beyond hardware agents or hosts. which are often integral to such systems as indicated in FIGS. 24-32. The horizontal dotted lines with arrows on the right side of FIGS. 22 and 23 are intended to convey (without limitation to specific entities) the ability of progressive agency computing systems/platforms, hardware agents and hosts, to communicate and interact with and successor computing devices and systems, and in general external entities (e.g., to transfer/convey data, information, and digital assets including rights, permissions and privileges etc.; to enable successors with agency).

FIGS. 1-34 each are illustrations of progressive agency systems, progressive smart contracts and methods, in accordance with the present invention.

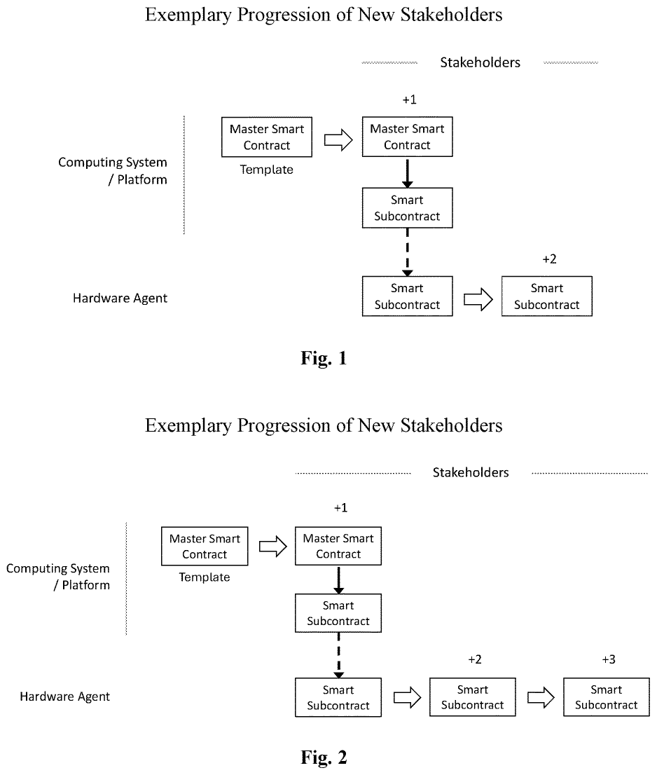

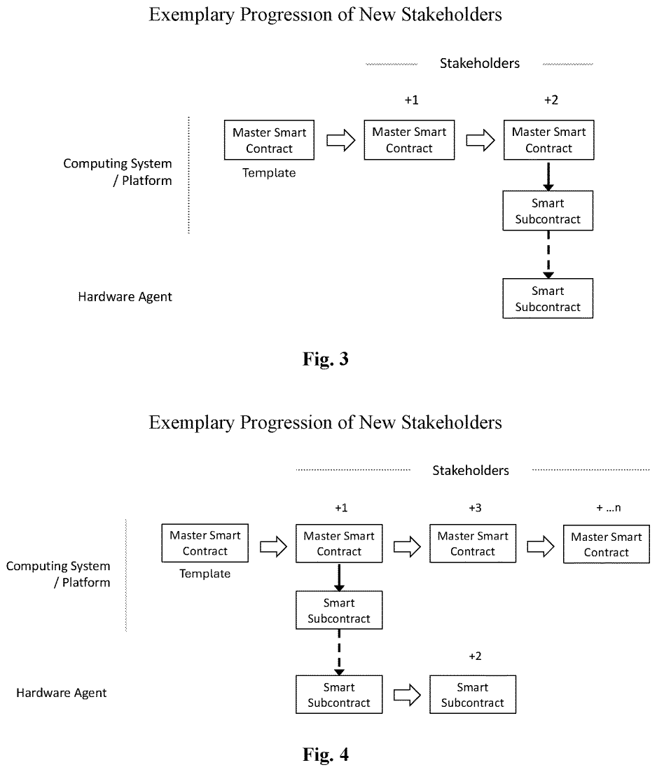

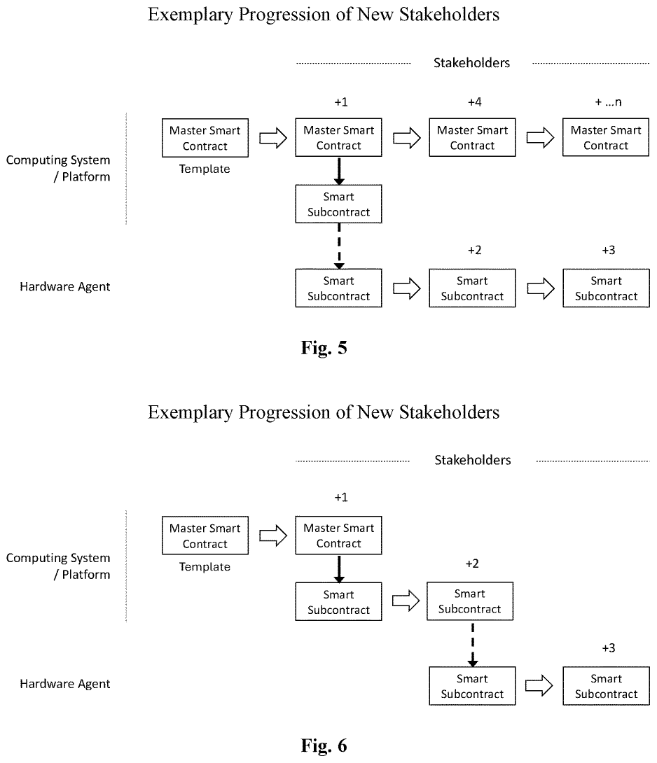

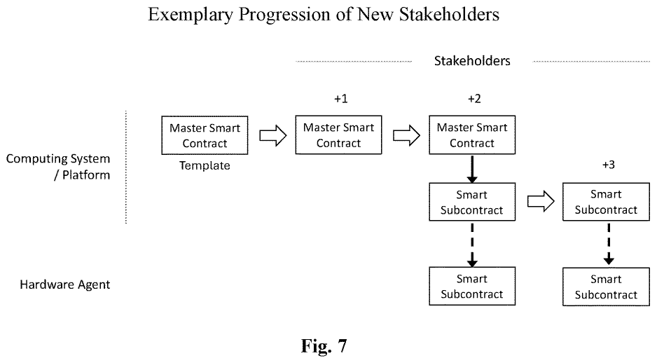

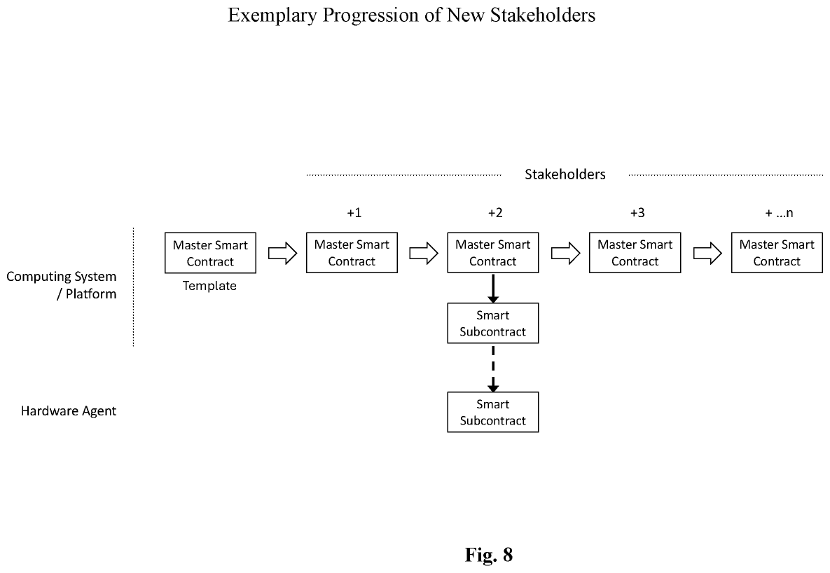

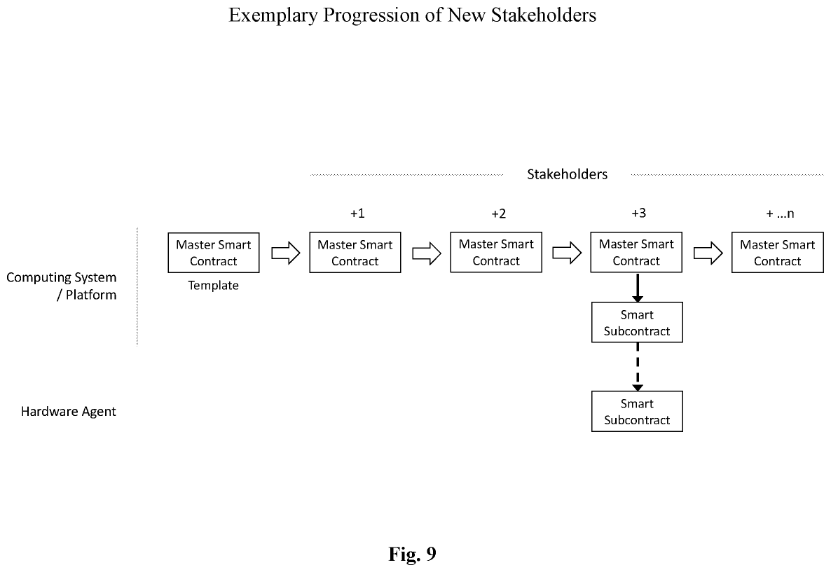

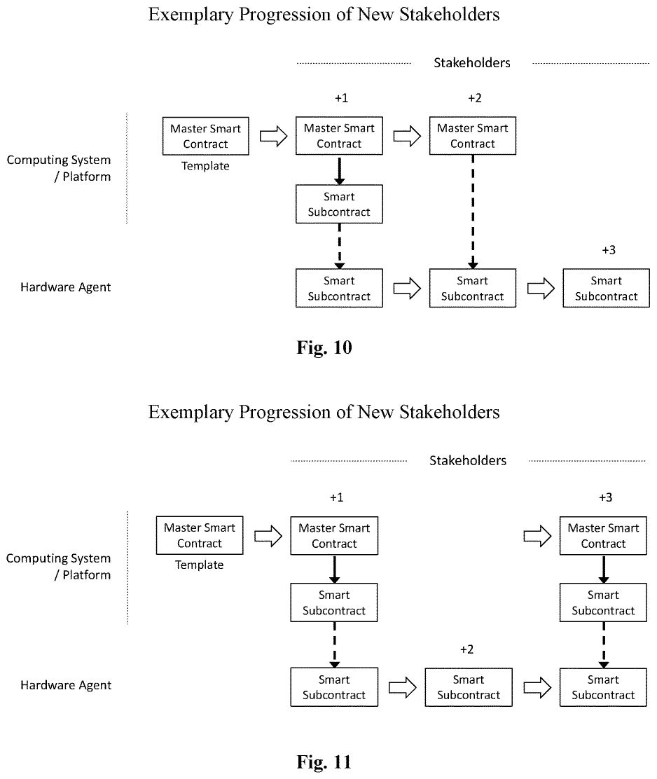

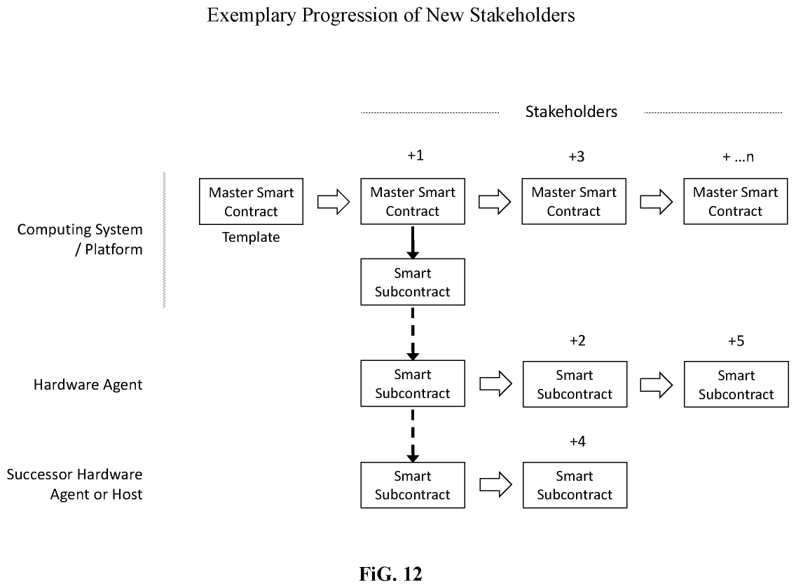

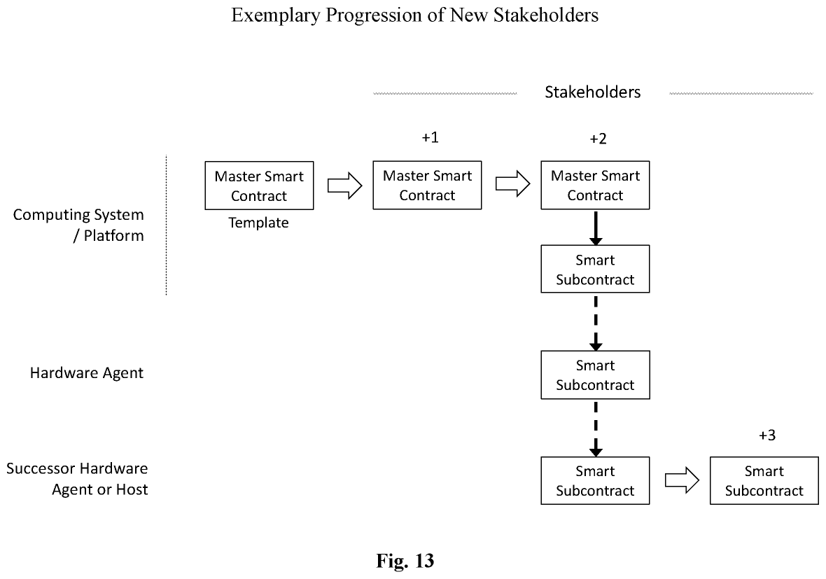

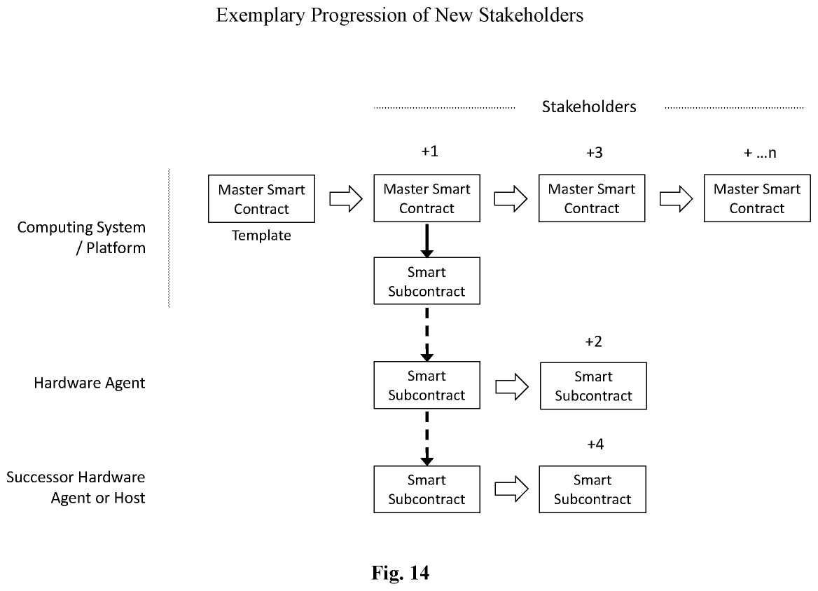

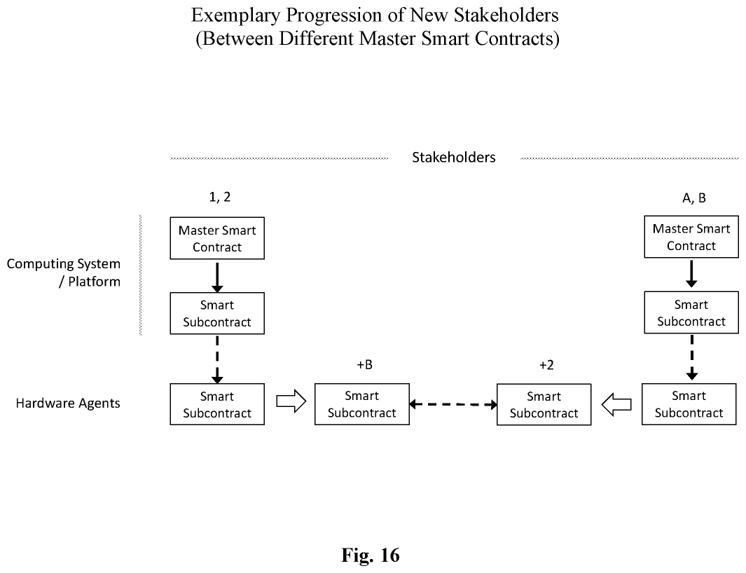

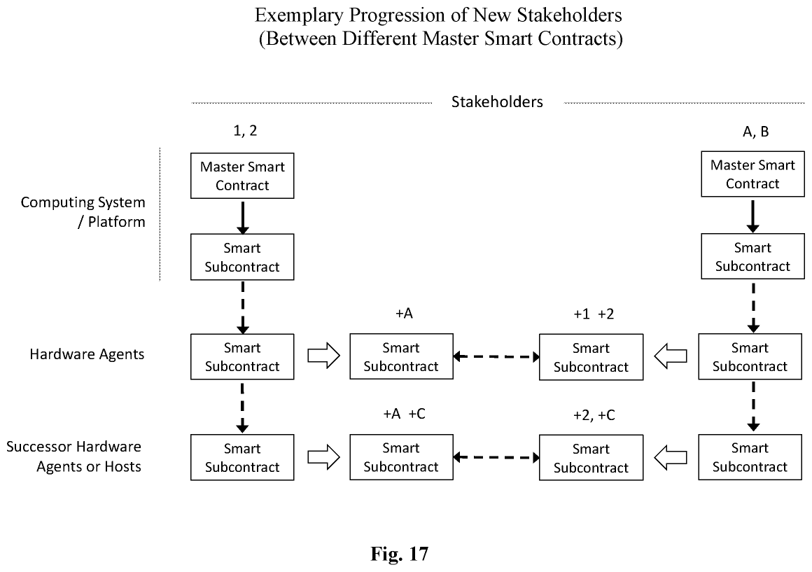

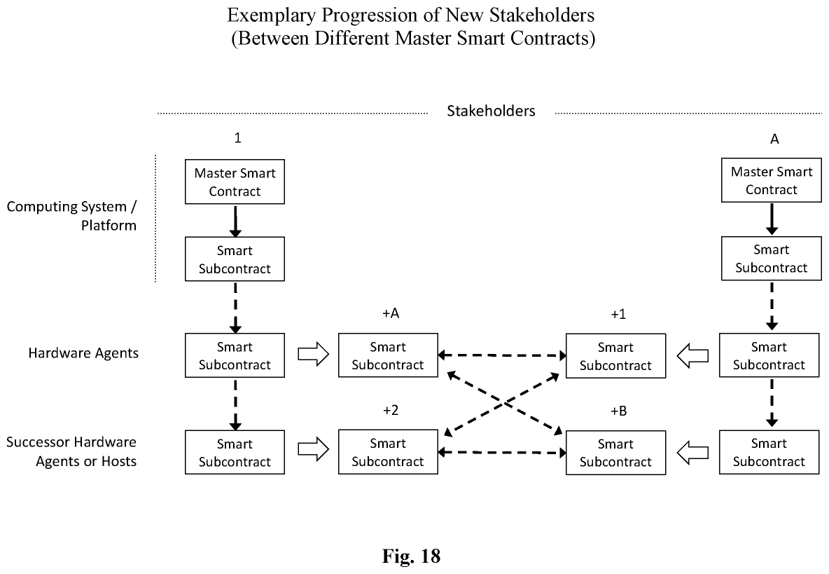

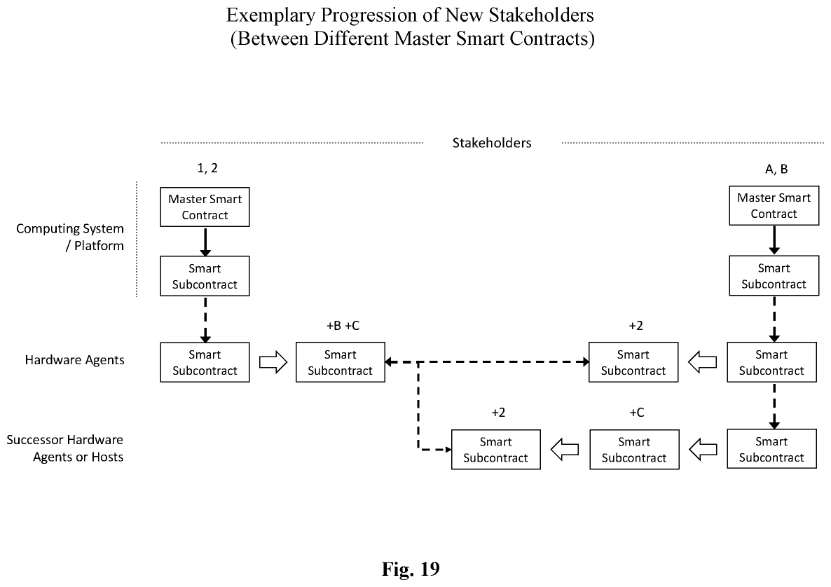

### FIGS. 1-19 Exemplary Progression of New Stakeholders

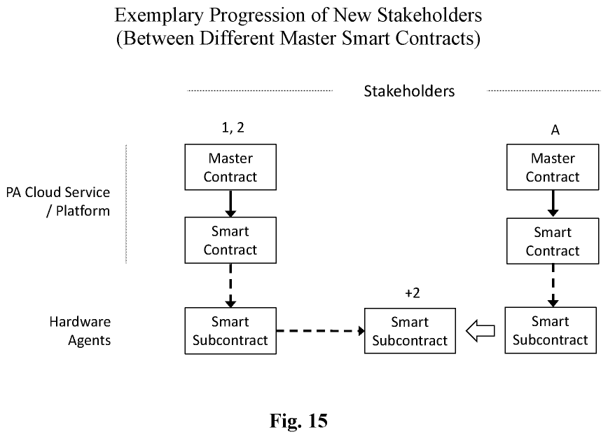

FIGS. 1-14 begin with a master smart contract template becoming a master smart contract with the registration of at least one initial stakeholder. In FIGS. 15-19 the initial instance of the master smart contract has one or more preset stakeholders. The Figures also illustrate interactions between hardware agents descended from two different master smart contracts, where the interactions result in new instances of smart subcontracts that have stakeholders descended from the two different master smart contracts. In short, the figures illustrate ways (of which there are many others) where a stakeholder in one item can add combine with another stakeholder in the same item. E.g., so that hardware agents attached to items (of the same or different types) and/or are from two different vendors, can update each other when they're combined in the same container or storage facility, kitted or assembled into a product (or replaced). Implicit is the ability of item-level smart subcontracts and hardware agents to interact with, to create ad-hoc networks with item-level smart subcontracts and hardware agents.

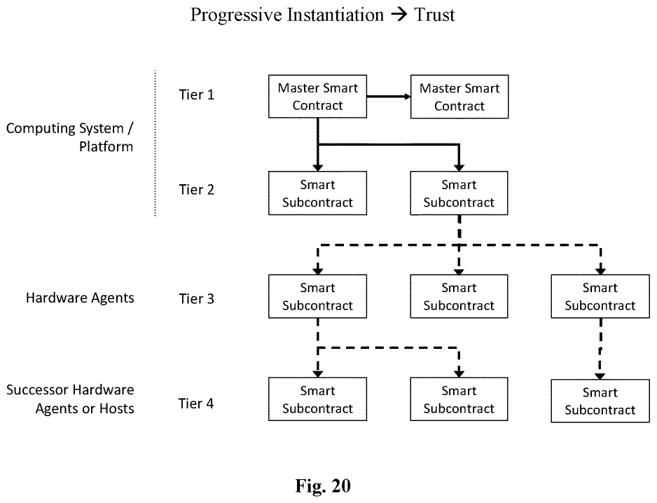

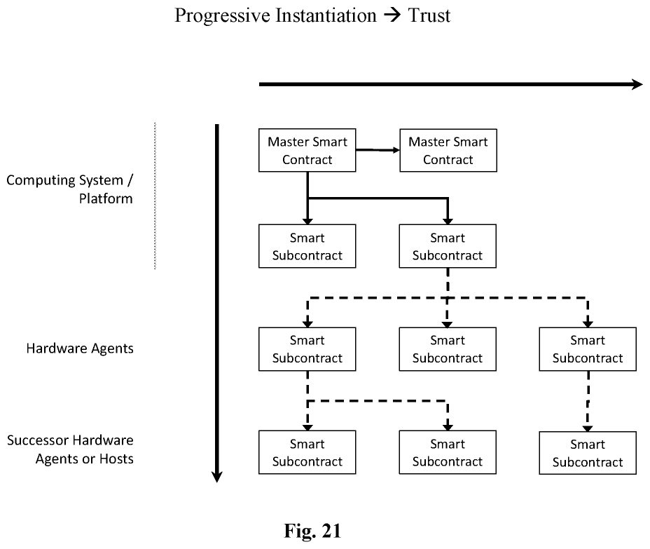

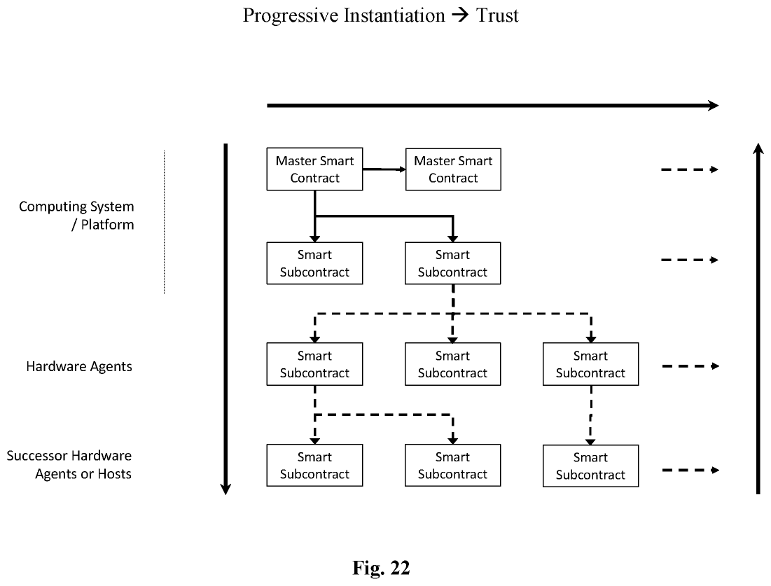

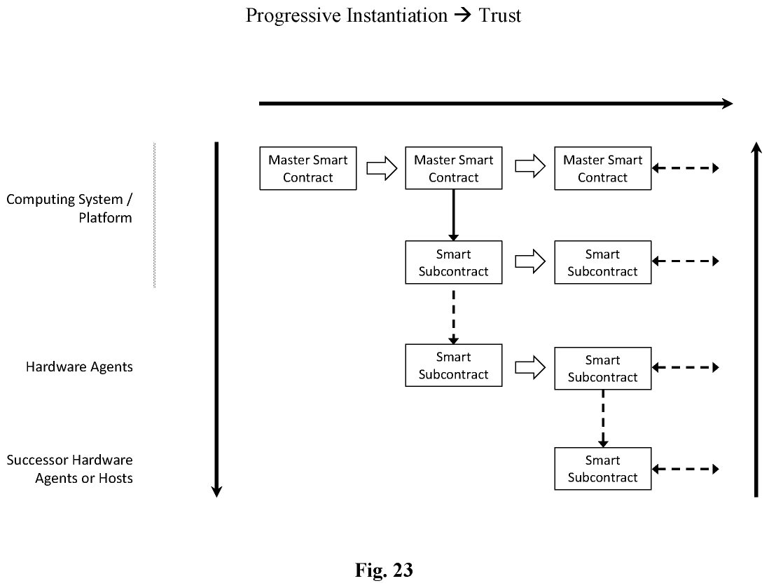

### FIGS. 20-23 Progressive Instantiation and Trust

This set of figures illustrate different progressive agency computing services/platforms, systems, smart contracts and hardware agents that together stakeholders can trust to project and preserve their individual interests from the time they ‘join’ (or are registered in) a smart contract (master, co-resident smart subcontract, item-level smart subcontract etc.) or receive data, information, digital assets—agency, from them.

FIG. 20 introduces ‘progressive instantiation and trust’ across ‘tiers’ of stakeholder systems, devices etc. Although not shown, tiers (or more broadly, dimensions) as frameworks/methods can play an important role in progressively organizing, configuring, harmonizing and managing different groups having distinct persona (such as stakeholders, smart contract, devices etc.), hierarchies and other relationships by, and between them, and rights, authorizations, stakes, roles etc.

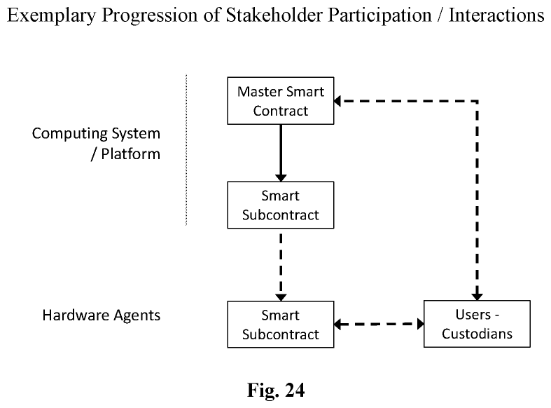

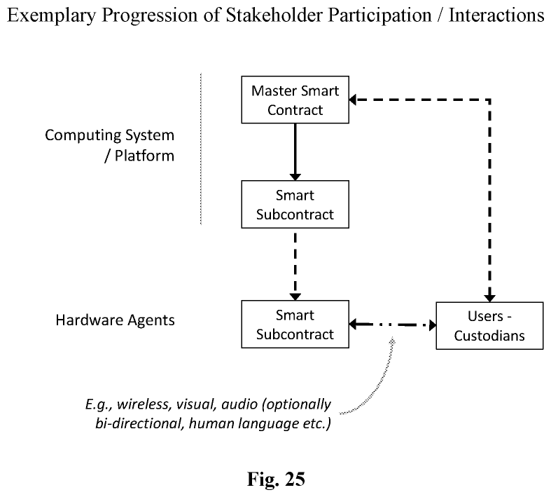

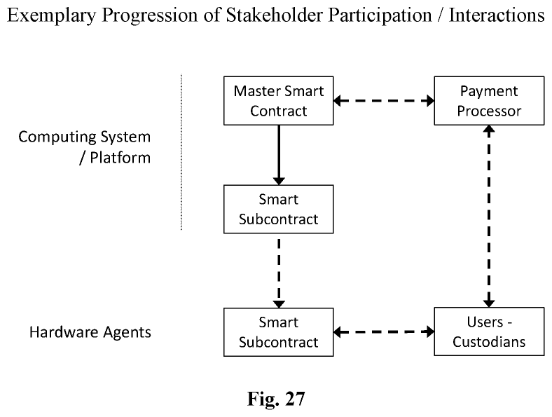

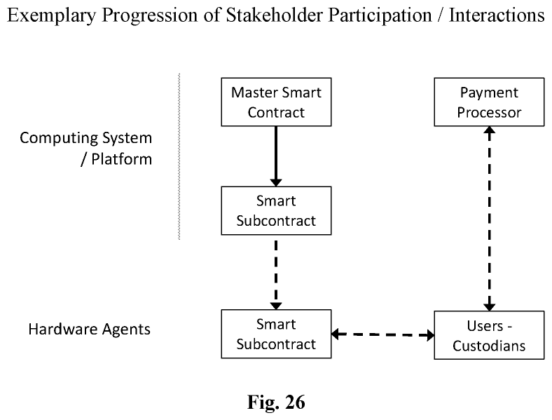

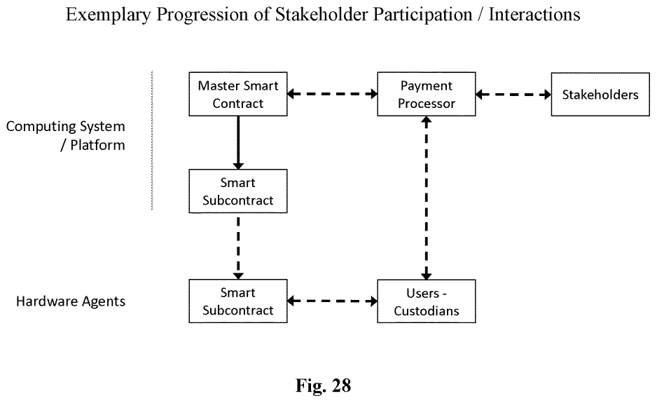

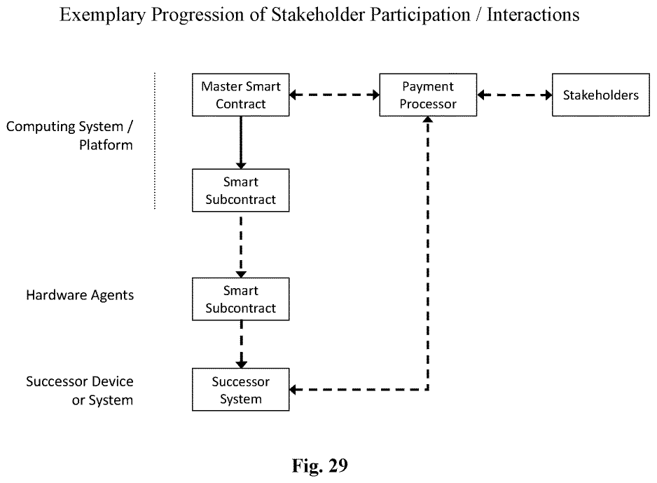

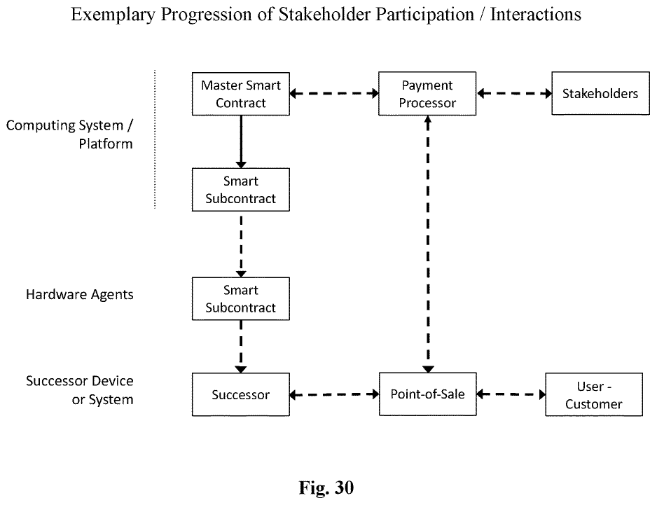

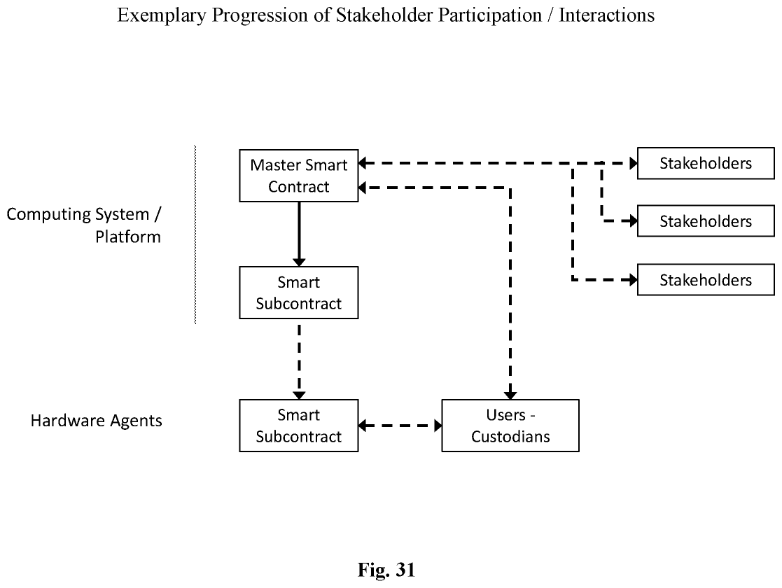

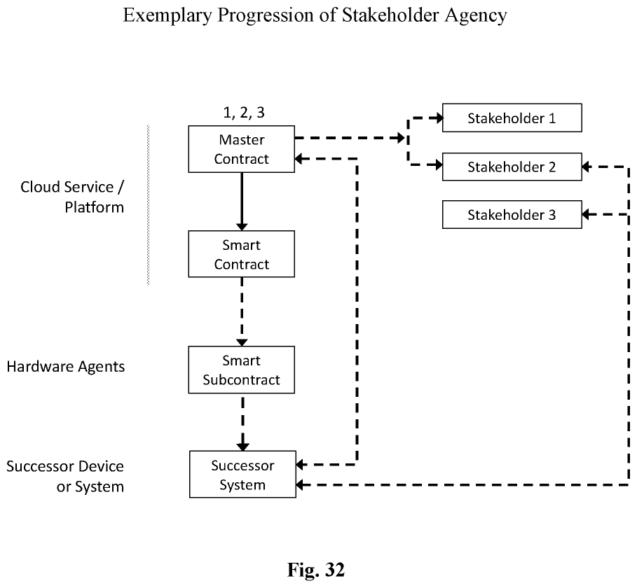

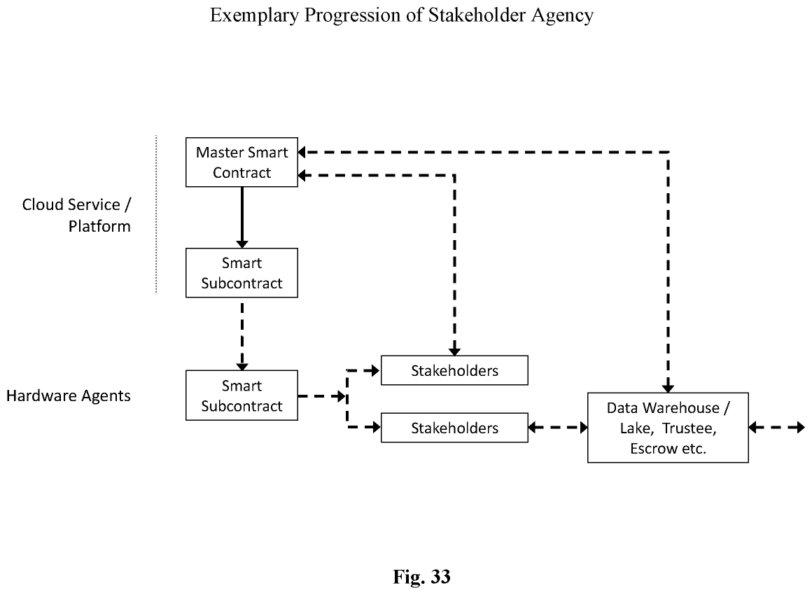

### FIGS. 24-32 Exemplary Progression of Stakeholder Participation/Interactions

This set of figures illustrates a few, simple examples of progressive stakeholder participation and interactions that go beyond hardware agents, e.g., to users, custodians (computing devices and systems alone or in combination) and remote stakeholders (e.g., directly, or by way of the progressive agency computing service/platform.

As illustrated by FIGS. 24-28 the interactions may be with or involve a proximate/local user or/and other custodian (device, system), that bridges to/from, a remote entity as shown. As illustrated in FIGS. 29-32, a hardware agent (or host) may however be configured with wide area communications (e.g., cellular or satellite) and be able to ad hoc communicate, interact directly or indirectly with, for example, a progressive agency computing system/platform, 3^{rd} party service providers (e.g., payment processors, data warehouses, escrow agents—often stakeholders in their own right) or remote stakeholders, (and the reverse).

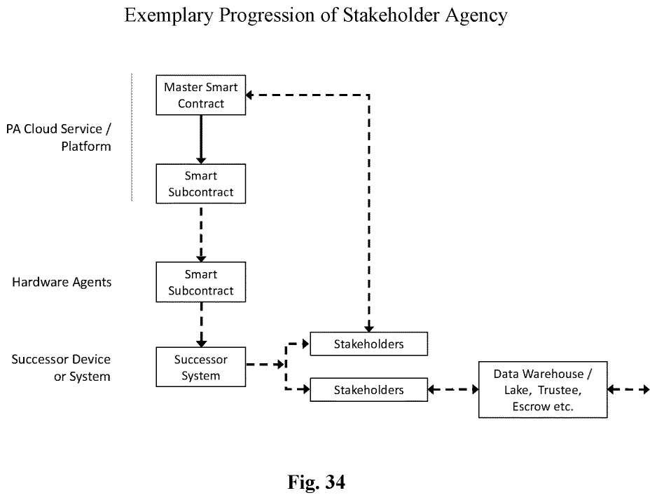

### FIGS. 33-34 Exemplary Progression of Stakeholder Agency

This set of figures underscore the kinds of interactions where progressive agency can enable successor parties (which may or may not be ‘stakeholders’) with agency to achieve their own purposes as well as those of other stakeholders.

### DETAILED DESCRIPTION

The descriptions and figures herein exemplify and/or build on commercial applications, system architectures, and hardware structures disclosed in the provisional, pending and issued patents listed above and incorporated herein by reference. It is to be understood that the progressive agency computing system/platform and services, progressive smart contracts, hardware agents etc. are not limited to the exemplary embodiments described or illustrated herein.

### Progressive Agency

Progressive Agency is a novel paradigm comprising (1) progressive agency computing systems/platforms (cloud or otherwise, advantageously artificially intelligent, AI powered), (2) hardware agents and hosts, and (3) progressive smart contracts. Progressive smart contracts comprise a master smart contract and smart subcontracts. The master smart contract and co-residing smart subcontracts are generated and operate on a computing system/platform, which together determine the operation of the computing system/platform as it relates to the progressive smart contract. Item-level smart subcontracts are stored in, and control the operation of, hardware agents and hosts. Note that smart subcontracts referred to as co-residing smart subcontracts may reside on a different computing system/platform from the where the master contract resides.

Master smart contracts and co-residing smart subcontracts each comprise an electronic contract and a registry, both of which are in whole or in part, immutable except as allowed by the current instance of the electronic contract and the current instance of the electronic registry. Together they, determine the autonomous or independent operation and performance of the computing system/platform as it pertains to the master smart contract and co-resident smart subcontracts, such as:
automatically executing, controlling or documenting events or actions of, or interactions with, the computing system/platform (as they pertain to the master smart contract and smart subcontracts), and
progressively registering new parties (stakeholders) in the master smart contract and co-resident smart subcontracts, and their ability to add to, subtract from or otherwise modify either the electronic contract or registry.

A master smart contract is generally considered to have been generated when one or more parties register with the master smart contract, and thus form-an initial instance of a registry. In some use cases, such as those illustrated in FIGS. 1-14, a master smart contract begins as a master smart contract template until an initial (first) stakeholder is registered. Master smart contract templates may be generated by AI agents (agentic AI or other AI systems) or provided by 3^{rd} parties (the same as, or different from, future stakeholders in the progressive smart contract). They may be tailored for a class or groups of subject items, their use or outcomes, prototypical distribution and business models, regulations etc. And they may also be tailored to the capacity, capability and intended use of the hardware agents in which an item-level smart subcontract will operate. In other use cases master smart contracts may have an ‘anchor’ stakeholder, e.g., a large e-commerce or bricks-and-mortar retailer or government agency, with preset predetermined terms and conditions, much as they do with master vendor agreements today. Such master smart contracts are equivalent to first instances of a master smart contract in which an initial (first) stakeholder has registered.

As allowed by the initial and subsequent instances of a master smart contract, a progression of stakeholders may register in the master smart contract over time. In the process a co-resident smart contract (described below) may be generated or a new current instance of the master smart contract. There are of course many possible sequences and variations.

Smart subcontracts may co-reside with a master smart contract (or a smart subcontract of a master smart contract etc.) on the same (or different) computer system/platform along with the master smart contract. Item-level smart subcontracts reside in hardware agents or hosts. Similar to master smart contracts and co-resident smart subcontracts, item-level smart subcontracts comprise an electronic contract and a registry, both of which are in whole or in part, immutable except as allowed by the current instance of the electronic contract and the current instance of the electronic registry. And as with master smart contracts and co-resident smart subcontracts, the electronic contract and registry of item-level smart subcontracts determine the autonomous or independent operation of hardware agents or hosts).

Note that by way of, and as allowed by, the electronic contracts and registries of master smart contracts, co-resident smart subcontracts and item-level smart subcontracts, successor parties beyond a progressive smart contract, can acquire agency by way of rights, permissions, privileges, authorizations and other digital assets, and data, information, etc. as described here and elsewhere herein. Their agency may be limited and subject to rules, predetermined conditions etc., but it isn't necessary for these ‘successor’ parties to be registered within the progressive smart contract to benefit by way of the agency they acquire.

### Hardware Agents

Exemplary hardware agents comprise an embedded system, the embedded system comprising various combinations of a:
Power Source
   preferably an onboard battery and/or an energy harvester
   and/or an interface to an external power source that is part of, or physically associated with, the item or the hardware agent
Control Circuitry comprising:
   a controller, logic, memory
   primitives, functions (hardware, firmware, software)
   operating instructions, programs, systems
   predetermined conditions
   a clock/timer
Sensing Circuitry configured fit-for-purpose to sense one or more ambient conditions (or those of the item), or more generally to “perceive” the item's environment or the item itself (e.g., it's condition, state or status).
Messaging Circuitry (e.g., visual (reflective, transreflective), optical (emissive), audible, tactile) for messaging alerts, notices and in general, data or information; outbound, unidirectional.
Communication Circuitry (e.g., EPCgen2/RAIN RFID, NFC, Bluetooth/BLE, Thread, WIFI, cellular, satellite) that may, for example, be configured:
   as a beacon or transmitter for example, to broadcast an identifier or “advertisement” for “discovery” by appropriately enabled devices such as mobile phones, tablets, notebooks or computers, or networks., or
   to respond to a wireless signal e.g., such as a query for or to update, the state, status or condition data or information (the query in response to, or regarding data or information related to messaging by messaging circuitry, e.g., a visual alert that prompts the query; receiving location data (e.g., GPS).
   passive (batteryless), active or ad hoc power enabled as disclosed in U.S. patent application Ser. No. 17/890,131 entitled “Ad hoc Power Enabled Communication”.

In some instances, the communication circuitry may include ‘wired’ communication circuitry, e.g., via surface contacts or connectors for ad hoc communications with local devices and/or systems.

The embedded system of a hardware agent may also be configured with an ‘actuator’ (wireless, contact, mechanical, optical etc.) to actuate, activate for example, an onboard power source and in turn activate, power the embedded circuitry.

Hardware agents are computing devices that operate autonomously or independently according to item-level smart subcontracts. Hardware agents are item-level, that is they can be affixed to, or otherwise bound to, embedded in, integrated into, an item (good, product or ‘thing’) or a primary or secondary package of the item, that is portable, transportable, or mobile. Depending on the use case, they may be fixed or stationary as well. In the broadest sense of the term, hardware agents are intelligent, and as defined by their role in progressive agency, they comprise artificial intelligence. The novelty of the inventions described herein does not depend on the level of a hardware agent's intelligence. The figures and related descriptions of progressive agency and progressive smart contracts that follow apply in any case.

The intelligence of a hardware agent may be simple, primitive or complex, and of one or more types including but not limited to:
simple reflex, model-based reflex
rules based, goal-based, utility based
learning
hierarchal, multi-agent (the same or different)

The intelligence of a hardware agent may also perform operations and processes such as:
sensing, perceiving
evaluating, reasoning, determining, decision-making
executing actions, performing
responding, learning and adapting
knowledge management

The actions taken by a hardware agent may, according to the current instance of it's smart subcontract (electronic contract and registry), modify the then current instance of the electronic contract (including one or more predetermined conditions) or the registry, and thereby modify the progressive smart contract of which it is a part.

Generally, the first instance of an item-level smart subcontract is descended from a then current instance of a master smart contract, or more likely, a co-resident smart subcontract. An exemplary system and method for provisioning hardware agents involves a computer system/platform that ‘packages’ a co-resident smart subcontract that will be subsequently received and ‘unpacked’ by a hardware agent, and thereby become a first instance of an item-level smart subcontract.

An exemplary simple hardware agent is one configured to provide conditional access to functions or features, and transferable media, rights, privileges, permissions and authorizations, tokens, stored values, security interests, titles, certificates, proofs, etc. (collectively “digital assets”), stored within it or an item to which the hardware agent is physically associated, and where the conditions depend on the current instance on an item-level subcontract.

### Progressive Agency Systems, Progressive Smart Contracts

In addition to a master smart contract, a single progressive smart contract may comprise millions of item-level smart subcontracts at one time, and many times that number over time.

Similarly, there may be many progressive smart contracts at any one time, and many times that number open over time. And across many progressive smart contracts a single party may have stakes in a very large number of smart contracts- and by extension, items, their use and outcomes.

With progressive agency stakeholders in progressive smart contracts and enabled successor parties (such as data analytic companies or data warehouses, transaction processors, certificate authorities, trustees, escrow agents, blockchains and other distributed ledgers, etc.) can use past and present data, information, and digital assets (especially proofs):
(1) generated, collected, transported, or distributed by the master smart contracts and smart subcontracts that comprise progressive smart contracts—collectively “progressive agency data”, or
(2) derived from, dependent on, or related to progressive agency data e.g., its use and users, events, actions, outcomes and their context
   environments, locations, times, weather, market conditions, as allowed by and in accordance with the electronic contracts and registries of master smart contracts and smart subcontracts. Among the many purposes for its use are for AI and other systems and methods to:
(1) learn and improve the:
   artificial intelligence of progressive agency computing systems/platforms, hardware agents and hosts, successor computing devices and systems;
   individual and collective agency of stakeholders and successor parties and systems, and the outcomes thereof;
   utility of hardware agents and that of items and more broadly things, to which they are affixed, embedded etc., and their uses and outcomes;
(2) progressively:
   harmonize, maximize stakeholder participation- and outcomes
   enable, generate, adapt, optimize:
      smart contracts (electronic contracts, predetermined conditions)
      stakeholder rights, privileges, permissions, authorizations (registry)
      the performance of hardware agents
      the individual and collective agency of the stakeholders in progressive smart contracts—and associate items, systems etc.
      the utility of ‘items’ (and ‘things’) and their use and outcomes
         packaging, handling, storage, distribution, transport
      individual and collective performances of the stakeholders
         according to the distribution of costs and benefits; pay-for-performance
      conditional, dynamic, contextual pricing
      marketplaces, auctions, competitive bidding
   detect, minimize, mitigate misuse, theft, fraud, risk; violations of smart contracts, e.g. privacy, anonymity, security interests, uses of data, information and digital assets etc.
   communicate with, and enable communications by and between, stakeholders
   develop AI language models and other forms of AI;
(3) forecast:
   diminished fitness-for-use (and thus outcomes) of items, and thus demand for replacements items, buffer inventory, overstock and related services
   demand for agency enabled services (e.g., by successor parties, devices, systems)
(4) process:
   transactions including for example, payment, settlement, insurance, finance, title and security interests, escrow, data) enabled (and obligated) for example, by way of data and information-'proofs'-generated by master smart contracts or smart subcontracts. Wherein the proofs include, but are not limited to, sensed conditions, events, actions, time, interactions with users and stakeholders, computing devices and systems; current instances of, or changes in, electronic contracts and registries; the utility of an item (or hardware agent), outcomes. Such data and information can also be used with, and transactions contingent upon, external data and information from trusted sources as weather services and financial markets;
(5) enable, interact:
   with, third party edge devices, apps and services, and thereby increase and improve user engagement and experiences, and streamline related workflows e.g., return processing for items with diminished utility and the settlement among stakeholders according to predetermined terms and conditions.

### Agency and Utility as Products, Assets and Services

From computing system/platforms to hardware agents, to successor hardware agents and hosts, to successor devices, systems and parties, and to items, the (1) agency enabled or performed, the (2) corresponding utility enabled or created, and the (3) purposes enabled or achieved (outcomes) with progressive agency, can each be measured, valued and priced similarly to products and services by type, class etc., individually and collectively, and at different times and over different periods of time. And the values and ‘prices’ can be established in ways other than strictly monetary e.g., in terms of:
trust, reliability, confidence, certainty, security
privacy, anonymity
compliance, adherence
relationships
transport, carriage, conveyance (of agency, utility, digital assets)
3999ease of use, access, experience, speed, efficiency
good will

Those measures and valuations in turn, can be used alone or in combination to harmonize stakeholders and ecosystems, and for stakeholders and ecosystems to harmonize their individual incentives, roles and participation.

While particular preferred and alternative embodiments of the present intentions have been disclosed, it will be appreciated that many various modifications and extensions may be implemented using the teaching of this invention. All such modifications and extensions are intended to be included within the true spirit and scope of the appended claims.

What is claimed, is:

1. A progressive agency system, comprising:
a progressive agency computing system and intelligent, item-level hardware agents that operate according to a progressive smart contract, the progressive smart contract comprising a progression of smart contracts including;
a master smart contract and one or more co-resident smart subcontracts, and item-level smart subcontracts conveyed from the one or more co-resident smart subcontracts; and
wherein:
(a) the computing system operates according to the master smart contract and co-resident smart subcontracts, and
(b) the hardware agents operate, according to their respective item-level smart subcontracts, and
the master smart contract and the smart subcontracts each comprise an electronic contract with predetermined conditions and a registry, both of which are in whole or in part, immutable except as allowed by a then current instance of the master smart contract, co-resident smart subcontract or item-level smart subcontract to be modified; and
wherein multiple parties, each according to its own purpose and as allowed by the current instance of a smart contract of the progressive smart contract, can register with their own rights, permissions, privileges and authorizations, and predetermined conditions, in the smart contract.

2. The progressive agency system of claim 1, wherein according to the master smart contract and co-resident smart subcontracts, the computing system operates autonomously or independently.

3. The progressive agency system of claim 1, wherein according to an item-level smart subcontract, the hardware agent operates autonomously or independently.

4. The progressive agency system of claim 1, wherein the computing system operates on a cloud computing platform.

5. The progressive agency system of claim 4, wherein a co-resident smart subcontract resides on a cloud computing platform different from the one where the master smart contract resides.

6. The progressive agency system of claim 1, wherein a hardware agent is affixed to, or otherwise bound to, embedded in, integrated into, an item or it's primary or secondary packaging.

7. The progressive agency system of claim 1, wherein a hardware agent is:
(1) single use, multi-use, reusable
(2) flexible, semi-rigid or rigid
(3) standalone, portable, transportable, mobile, stationary
(4) self-contained, as an item unto itself

8. The progressive agency system of claim 1, wherein hardware agents comprise combinations of: a power source, control circuitry, sensing circuitry, messaging circuitry, and communication circuitry.

9. The progressive agency system of claim 1, wherein the intelligence of a hardware agents is simple, primitive or complex.

10. The progressive agency system of claim 1, wherein the intelligence of a hardware agent is one or more of:
(1) simple reflex, model-based reflex
(2) rules based, goal-based, utility based
(3) learning
(4) hierarchal, multi-agent (of the same or different types)

11. The progressive agency system of claim 1, wherein according to an item-level smart subcontract, a hardware agent performs operations, processes or methods including:
(1) sensing, perceiving
(2) evaluating, reasoning, determining, decision-making
(3) executing actions, performing
(4) responding, learning and adapting
(5) knowledge management

12. The progressive agency system of claim 1, wherein according to the current instance of a smart contract of the progressive smart contract; data, information or digital assets are conveyed from:
(1) a computing system to a hardware agent,
(2) a hardware agent to a successor hardware agent or host, or
(3) a hardware agent or successor hardware agent or host, to an item or a successor, computing device or system, wherein, the item or successor computing device or system, does not operate according to a smart contract of the progressive smart contract.

13. The progressive agency system of claim 11, wherein the smart contracts are of the same or different progressive smart contracts.

14. The progressive agency system of claim 11, wherein the digital assets comprise:
rights, permissions, privileges and authorizations, or
proofs of states or conditions, events, actions, performances, or
tokens, stored value, security interests, title, or
content, media 15. The progressive agency system of claim 1, wherein by way of the registry or the electronic contract of a smart contract, each party in the registry is enabled with its own agency to achieve its own purpose.

16. The progressive agency system of claim 14, wherein the agency of each party in the registry is automatically performed in whole or in part, according to the electronic contract and predetermined conditions of the smart contract of the progressive smart contract.

17. The progressive agency system of claim 11, wherein according to the current instance of a first smart contract, the conveyance of data, information or digital assets to a second smart contract conveys the agency of the parties to the first smart contract.

18. The progressive agency system of claim 1, wherein by way of the registry and the electronic contract of a smart contract of the progressive smart contract, each party to the smart contract is enabled with its own agency.

19. The progressive agency system of claim 1, wherein each party's agency is automatically performed in whole or in part, according to the electronic contract, registry, and predetermined conditions of the smart contract of the progressive smart contract.

20. The progressive agency system of claim 11, wherein some or all of the (1) agencies enabled or performed, the (2) corresponding utility enabled or created, and their (3) purposes enabled or achieved with a progressive agency system, are measured, valued or priced individually, collectively, or in combination.

21. The progressive agency system of claim 1, wherein a hardware agent operating according to an item-level smart subcontract enables or is enabled by an item to which the hardware agent is physically associated, with agency.

22. The progressive agency system of claim 1, wherein a hardware agent operating according to an item-level smart subcontract of the progressive smart contract, enables a successor device, system or party with agency.
